(19) United States
(12) Patent Application Publication
(10) Pub. No.: US 2003/0063066 A1
(43) Pub. Date: Apr. 3, 2003

(54) Computer peripheral device

(76) Inventor: Barry Allen Thomas Brown, Woodlands (GB)

Correspondence Address: HEWLETT-PACKARD COMPANY, Intellectual Property Administration, P.O. Box 272400, Fort Collins, CO, 80527-2400, US

(21) Appl. No.: 10/255,837

(22) Filed: Sep. 27, 2002

(30) Foreign Application Priority Data
Sep. 28, 2001 (GB) 0123470.7

(51) Int. Cl. G09G 5/00

(52) U.S. Cl. 345/156

(57) ABSTRACT

A computer peripheral device, electrically couplable to a personal computer having a processor operable to process digital audio data, the peripheral device comprising a user interface manually operable by a user to supply instructions to the said processor to specify processing operations to be performed by the processor on the digital audio data and to select an audio processing device for converting digital audio data to an analogue audio signal, the computer peripheral device further comprising an audio processing device for converting digital audio data to an analogue audio signal, said audio processing device being selectable by the user interface.

### BACKGROUND TO THE INVENTION

An important part of music consumption are creative activities which produce or reproduce music. Whilst people continue to enjoy playing traditional musical instruments, in recent years electronic or computer-based music making has increased in popularity.

Computer-based music making takes many forms, for example, composition and/or sequencing of synthesised music. However, just as people are generally required to have training and a reasonable degree of proficiency in order to play a musical instrument, then so too are they usually required to have musical knowledge and an appropriate level of skill in order to gain satisfaction from most aspects of electronic music synthesis. Although many people have access to a personal computer (PC) capable of generating music, a substantial number are excluded from enjoying this aspect of music making due to a lack of training or skill.

Amateur DJ-ing is another type of music making which provides practitioners with a satisfying and enjoyable pastime but requires less prior training and technical skill than the activities mentioned above. DJ-ing involves mixing records into each other and also ‘scratching’ them (i.e. moving the turntable by hand to create interesting audio effects), and is a common activity amongst dance music enthusiasts in particular. This activity however requires the participant to make a major investment by buying at least two record decks and a mixer, or alternatively obtaining a CD DJ system typically incorporating two CD players and a mixer. Such apparatus (be it for vinyl records or CDs) is relatively expensive, typically costing upwards of £1000. A CD-based system is particularly expensive if the user desires the ability to ‘scratch’ with CDs. For example, two scratchable CD DJ decks (such as the American DJ (RTM) ‘Pro-Scratch 1’) and a suitable mixer would cost in the order of £2000. These costs are prohibitively expensive for many amateur enthusiasts.

Today, CDs are very much more prevalent than vinyl records. Many people nowadays do not own vinyl records at all. This clearly presents the potential amateur DJ with a difficulty in that he is either required to spend a substantial sum of money on a CD-based system (preferably one which enables scratching) so that he can use his collection of CDs, or to spend less on the requisite equipment but invest in new vinyl records in order to be able to mix them. Because of these problems, many people who would be keen to try their hand at amateur DJ-ing are prevented from doing so.

One way of overcoming the problems associated with amateur DJ-ing identified above is to use a PC on which the music to be mixed has been stored in a digital format such as MP3. Music may readily be transferred from a CD onto a hard drive of a PC, and can then be played through the sound card of the PC. Existing sound cards allow the simultaneous reproduction of two audio tracks, and existing ‘virtual DJ’ software packages such as AtomixMP3 (http://www.atomixmp3.com) enables the user to mix two tracks.

It should be emphasised that any reference herein to a ‘sound card’ also includes an audio chipset which provides the ability to convert a digital audio signal into an analogue audio signal which is then amplified in order to drive speakers or headphones.

A key aspect of DJ-ing is the ability to listen on headphones to one track whilst another is being broadcast over speakers. This enables the user to prepare or ‘cue’ one track whilst the other is playing, thereby enabling him to fade or cut between the tracks at an appropriate moment. It is important to be able to listen to the track to be introduced in advance, in order to be able to start it at an optimum place (which is very commonly not at the beginning of the track). This normally necessitates buying and installing two sound cards for the PC, assigning one sound card to generate music to be broadcast over the speakers whilst the other plays music to be cued over a set of headphones. Whilst many PCs are pre-installed with one sound card, many users are very unwilling to undergo the inconvenience of purchasing a second sound card and then installing it within the PC. Moreover, many PC users may not have the skill and/or confidence to install a sound card, and accordingly may be dissuaded from using their PC for amateur DJ-ing.

Provided the user has the necessary sound cards installed in the PC, software such as AtomixMP3 running on the PC does not provide an authentic emulation of a real DJ's audio equipment. This is because the user interacts with the software via the computer monitor, supplying instructions to the software by clicking on on-screen icons using a mouse. Such a user interface does not and cannot realistically replicate a real mixing deck and a pair of record or CD decks. Indeed, much of the enjoyment to be obtained from amateur DJ-ing results from moving the faders and manually scratching the records (i.e. turning the record decks by hand). On-screen computer graphics and a user interface based around a mouse (or a computer keyboard) are unable to provide as satisfying an experience as authentic tactile DJ equipment.

It is a general object of the present invention to overcome or at least mitigate at least some of the problems identified above.

### SUMMARY OF THE INVENTION

According to a first aspect of the invention there is provided a computer peripheral device, electrically couplable to a personal computer having a processor operable to process digital audio data, the peripheral device comprising a user interface manually operable by a user to supply instructions to the said processor to specify processing operations to be performed by the processor on the digital audio data and to select an audio processing device for converting digital audio data to an analogue audio signal, the computer peripheral device further comprising an audio processing device for converting digital audio data to an analogue audio signal, said audio processing device being selectable by the user interface. This has the advantage of providing the user with a device which, in conjunction with a PC and suitable software for mixing and manipulating digital music, may authentically replicate the principal features of a club DJ's mixing deck. Through using this device the user may be given a greater feeling of satisfaction and fun than is possible with conventional digital music mixing software controlled on-screen using a mouse. The user interface may be manufactured as a relatively cheap accessory for a PC, bringing amateur DJ-ing to the majority of computer owners and enabling them to enjoy this in an intuitive hands-on manner.

If stereo signals are used, as is highly likely, then it must be emphasised that an ‘audio output’ as discussed herein should be interpreted as being a stereo output—which may itself comprise a pair of outputs designated ‘left’ and ‘right’. For the avoidance of uncertainty, a stereo output pair (i.e. a left and a right output) should be considered as constituting a single audio output if stereo is used. Alternatively, if mono signals are used, then a single stereo output may be used to provide two independent mono outputs.

Preferably the audio processing device for converting digital audio data to an analogue audio signal comprises a device selected from a group comprising: a sound card, an audio chipset. This may have one independent audio output, to serve in addition to a sound card installed in the PC, or may have two independent audio outputs for use with PCs which do not have a sound card installed internally. Either way, when in use this feature advantageously results in the PC being provided with two independent audio outputs.

Preferably the computer peripheral device further comprises a port for electrically coupling a pair of headphones to an output from the audio processing device. This feature advantageously enables the user to listen to a digital audio signal over headphones instead of playing it over speakers, and thereby provides a means for cueing an audio track.

Preferably the computer peripheral device further comprises a port for electrically coupling one or more speakers to an audio output from the audio processing device. This feature is particularly advantageous if the PC does not have a built-in sound card and if the sound card provided in the peripheral device has two independent audio outputs. It will be appreciated that the object of this feature is to provide a means by which the PC and peripheral device are able to have, between them, two independent audio outputs: one output for speakers and one for headphones.

Preferably the computer peripheral device further comprises a headphone selector control operable to select a digital audio signal to be played over headphones and not over speakers. This advantageously enables the user to specify a digital audio signal to be cued in advance of playing out over the speakers. By listening to the audio signal (e.g. a music track) over headphones the user can verify that it is appropriate for inclusion in the sequence of tracks being mixed, and can also prepare in advance the volume setting for the track and the point through the track at which it is to be started.

Preferably the computer peripheral device is connectable to the computer via a USB cable. This advantageously provides a straightforward means by which to connect the devices. However, it will be appreciated that other cable formats such as parallel, SCSI or FireWire may also be suitable, along with wireless data communication protocols such as Bluetooth (RTM).

To create an authentic reproduction of the controls of a real club DJ's mixing deck, preferably the manually operable user interface comprises controls operable to start and stop playing a digital audio signal, a fader for adjusting the volume at which a digital audio signal is played, and controls operable to adjust the bass and treble of a digital audio signal being played. It will be appreciated that these controls are not all required in combination, and that two or more sets of these controls may be provided to enable different audio tracks to be simultaneously and independently adjusted.

Preferably the computer peripheral device further comprises controls operable to apply audio effects to a digital audio signal being played. The ability to provide this feature advantageously arises as a consequence of the peripheral device operating purely with digital signals. Audio effects, such as echo, distortion and reverb, may be selected by the user on the peripheral device and the software causes the desired effects to be applied to the digital audio signal.

Preferably the functions performed by manually operable user interface may be assigned or reconfigured by a user. This advantageously allows the user to customise the controls of the peripheral device to suit his preferences or requirements at the time. For added authenticity, preferably the manually operable user interface comprises a jog dial for cueing a digital audio signal to be played and/or for applying a DJ's scratching effect to a digital audio signal being played. Again, it will be appreciated that two or more of these jog dials may be provided. Such a jog dial may be manipulated as a substitute for a real DJ's turntable, allowing an audio track to be cued up and also permitting the user to apply a scratching effect on a track that is playing.

Advantageously, to enable the user to mix music without needing to interact with the PC, the peripheral device preferably further comprises controls operable to select a digital audio signal to be played. Likewise, so that the user does not have to look unduly at the computer screen whilst operating the peripheral device, preferably the peripheral device further comprises a display operable to show the filename or other identifier of a digital audio signal being selected or played, and/or its duration or elapsed time.

Preferably the peripheral device further comprises a visual level meter to indicate the audio level of a digital audio signal being played.

Preferably the digital audio signals are in MP3 format. These may be stored on the hard drive or other storage medium of the computer. However, the digital audio signals may also be obtained from a CD or a minidisk under the control of the computer, advantageously enabling the user to mix music from CDs or minidisks without first having to transfer them to the hard drive of the computer.

According to a second aspect of the invention there is provided a computer peripheral device, electrically couplable to a personal computer such as an IBM-compatible or an Apple Macintosh computer having a processor operable to process digital audio data, the peripheral device comprising a user interface manually operable to cause the said processor to process the said digital audio data and to select the nature of the processing, the user interface comprising controls selected from a group comprising: moveable faders, jog dials.

According to a third aspect of the invention there is provided a computer peripheral device electrically coupled to a personal computer having a processor operable to process digital audio data, the processor running software to configure it to respond to instructions provided by a manually-operable user interface on the peripheral device, the said instructions specifying processing operations to be performed by the processor on the digital audio data and selecting an audio processing device for converting digital audio data to an analogue audio signal.

### BRIEF DESCRIPTION OF THE DRAWINGS

Embodiments of the invention will now be described, by way of example, and with reference to the drawings in which:

FIG. 1 illustrates an external view of a mixing deck constructed according to aspects of the invention; and

FIG. 2 illustrates schematically the internal electronic architecture of a mixing deck connected to a PC.

### DETAILED DESCRIPTION OF PREFERRED EMBODIMENTS

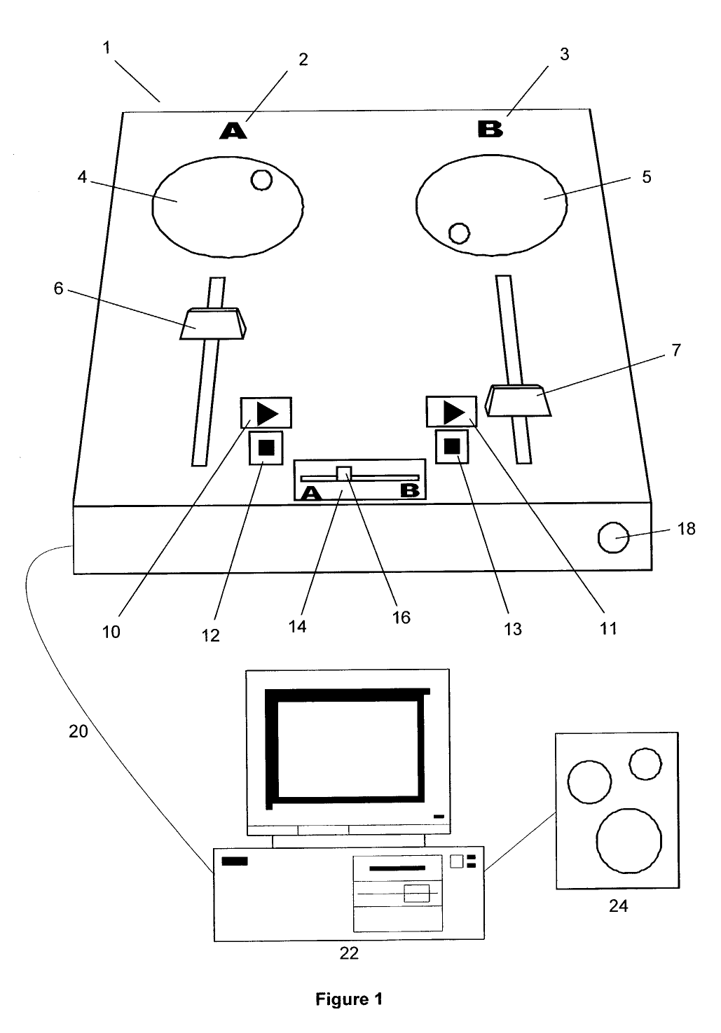

An example of a mixing deck made in accordance with the invention is illustrated in FIG. 1. The mixing deck 1 is supplied as a computer peripheral device which, in use, is connected to a PC 22 and placed somewhere alongside. It will be appreciated that a device embodying the same features of this external mixing deck could be made for incorporation within the body of a PC (e.g. located in a spare expansion bay and offering controls through the front panel of the computer) although this is not presently preferred.

In use, the mixing deck is connected to a PC 22 via a cable 20. In the interests of compatibility, standardisation and ease of connectivity the cable 20 is preferably a USB cable terminating in a standard USB connector, which is inserted into the corresponding socket provided on the PC (in which a suitable software driver has been installed). It will be appreciated, however, that other cable formats such as parallel, SCSI or FireWire could also be used, along with wireless data communication protocols such as Bluetooth (RTM).

The PC 22 is required to run software configured to support the mixing deck. This software is similar to existing ‘virtual DJ’ software, but enables the user to supply instructions to the computer processor by interacting with the mixing deck instead of using the mouse to click on on-screen icons. It is envisaged that existing virtual DJ software may be readily configured to support the mixing deck. The software allows the user to select from a directory of digital audio files (e.g. in MP3 format) as may be provided on the hard disk of the computer or on a CD, and also allows the user to manipulate digitally and play at least two such digital audio files simultaneously by taking action with the mixing deck. The PC's processor and hard disk are required to be sufficiently fast to enable this.

The playing and mixing of digital music involves the computer generating streams of digital audio data which are then processed digitally before being converted by one or more sound cards into audio signals for driving speakers or headphones. The present mixing deck operates within the digital stage of this process.

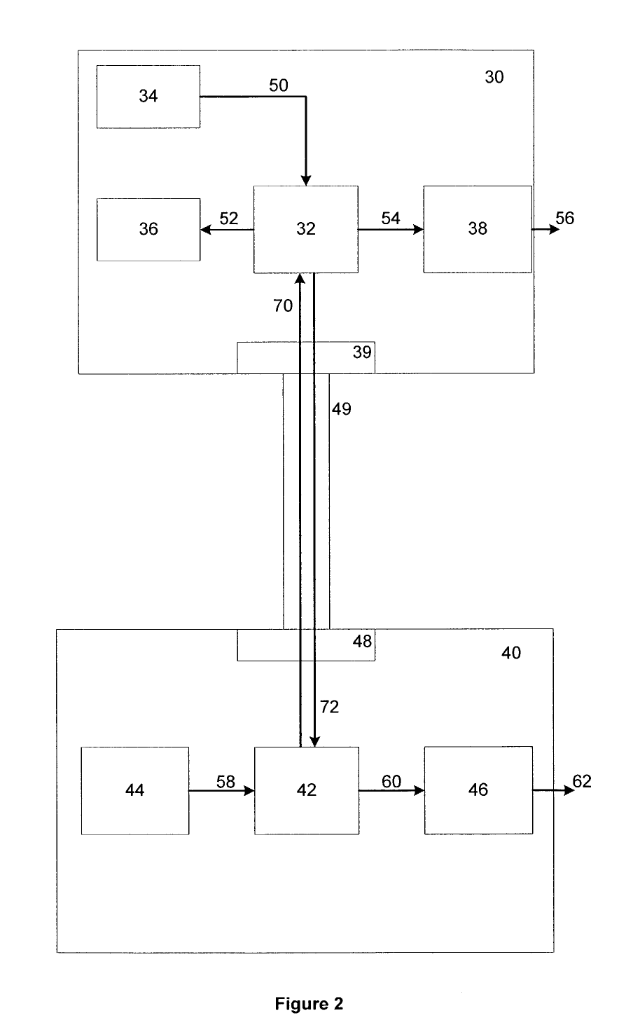

Internally, the mixing deck comprises a processor which is electrically coupled to the connection cable 20 in use. By means of the cable 20 the mixing deck's processor is electrically connected to the processor of the computer 22. The mixing deck's processor is also connected to the controls provided on the exterior of the mixing deck. The specific functions of these controls will be described later. As the user operates these controls, digital instruction signals are sent from the mixing deck's processor to that of the PC. These instruction signals are then interpreted by the PC's processor, which processes the digital audio data in accordance with the instructions supplied by the user through operating the controls on the mixing deck. The electronic architecture of the system as a whole will be described in more detail later, with reference to FIG. 2.

As will be explained in more detail below, to optimise the functionality of the system and the authenticity of the DJ-ing experience, it is necessary to be able to supply independent data to, and independently control, an audio output for speakers and a separate audio output for headphones. The present mixing deck serves to supply the computer with instructions from the user as to how to process the digital audio signals and which sound card output is to be used for playing which signals.

As mentioned above, two independent audio outputs are required—one for speakers and one for headphones. Each of these outputs is controlled by a sound card. Many PCs have a sound card installed, which usually provides a single audio output. A minority of sound cards provide a second independent audio output. In using the present mixing deck the user is required to have available at least two independent audio outputs. The mixing deck, in accordance with the invention, may have a sound card built in. A variety of configurations of the mixing deck are possible, with the number of independent audio outputs provided by the computer determining the configuration of the mixing deck that is used.

The following examples illustrate this point: If the PC has an internal sound card which provides two independent audio outputs then a mixing deck may be used that does not itself have a sound card built in. However, it is envisaged that commonly a user would have a PC having a sound card with a single audio output, and accordingly would require a mixing deck pre-installed with a sound card also having a single audio output. A further possibility is that the PC may not contain a sound card at all, in which case a mixing deck is used which has a sound card (or two sound cards) providing two independent audio outputs. The net result is that the combination of the PC and the mixing deck has at least two independent audio outputs.

FIG. 1 illustrates the embodiment in which the PC 22 has a single audio output and accordingly the mixing deck incorporates a sound card. The PC is connected to one or more speakers 24 for the transmission of audio such that people in the vicinity (e.g. dancers) can hear it. The audio output of the internal sound card within the mixing deck is connected to a port 18 in which a pair of headphones is plugged. (It will be appreciated that an alternative configuration of this system would be for the speakers to be connected to the sound card output of the mixing deck, and for the headphones to be connected to that of the PC.)

If the PC has two independent audio outputs then the speakers would be connected to one and the headphones to the other. Similarly, if the mixing deck is provided with a sound card such that it has two independent audio outputs then one would be used for the speakers and the other for the headphones.

Through interacting with the software on the computer 22 the user selects two independent digital audio streams, each of which is typically a music track. The mixer has two digital channels 2,3 (denoted as A and B) which correspond to the two tracks that have been selected. It will be appreciated that this invention may readily be extended to more then two channels. For each channel the mixer provides a play button 10,11 and a stop button 12,13. These buttons are used to instruct the computer to start or stop each track playing—i.e. to send or not to send each digital audio data stream to at least one of the sound outputs provided. A single button could perform both play and stop functions. These buttons may also incorporate a feature for pausing a track. The volume level at which each track is (or would be) played is adjustable by moving the respective fader controls 6,7 up or down. Bass and treble digital adjustment controls may also be provided for each channel.

Each channel on the mixing deck is also provided with a jog dial 4,5. The jog dials are configurable by the user to provide different features. For example, the jog dials may be configured such that, if a track is playing, then by rotating the appropriate channel's jog dial a DJ's scratching effect will be applied (in real time) to the audio output corresponding to that channel. The jog dial is designed to emulate a conventional DJ's turntable, and the scratching effect that is applied to the audio output is determined by the degree to which the jog dial is moved and the rate at which this is done. In an alternative configuration, jog dials may be used to fast forward or reverse through a track—a feature which is especially relevant when cueing a track over headphones, as will be described later.

In accordance with the instructions provided by the user via the mixing deck, the PC causes the audio to be played through an audio output, using the sound card appropriate to that output to convert the digital audio data into analogue audio signals. Commonly the speaker output, through which either or both channels may be played, is used. If two tracks are being played simultaneously, with each controlled by a separate channel on the mixing deck, then the digital data is combined prior to conversion by the appropriate sound card. Techniques for the processing of digital audio data are well known to those skilled in the art.

An important aspect of DJ-ing is being able to cue up a track over headphones before playing it over speakers. The present mixing deck provides this facility, since two independent audio outputs are provided, thereby enabling a track to be played over headphones whilst another is simultaneously played over speakers.

In order to specify that a particular, channel's digital audio signal is to be played over headphones and not over speakers, the mixing deck is provided with a selector 14 having a sliding knob 16 (or alternatively other selection means such as a lever) that may be moved to specify the channel, ‘A’ or ‘B’, to be played over headphones. If the knob 16 is not moved to a position corresponding to either channel ‘A’ or ‘B’ then both channels are played over the speakers and neither over headphones. However, if a channel is selected to be played over headphones then the corresponding digital audio data stream is sent by the PC's processor to the sound card providing output to the headphones, and not to the output that supplies the speakers.

When playing a track over headphones, the appropriate jog dial may be used to move rapidly backwards and forwards through the track so that the user can locate the best point at which to start playing the track over the speakers. This technique would be used, for example, in mixing a second track into the end of a first track: The first track is playing over speakers and is controlled with a first channel on the mixing deck. The user moves the headphone selector knob 16 to the position corresponding to the second channel (i.e. which controls the second track) and cues the second track over headphones using the jog dial. Having found the desired start point for the second track, the user pauses it and then moves the headphone selector knob 16 to a position such that neither channel is selected for playing over the headphones. Accordingly, on starting the second track playing again, it will be played over the speakers. The user restarts the second track at an appropriate time during the first piece of music, and may well simultaneously adjust the volume faders 6,7 to fade out the first track and to fade up the new track.

The mixing deck may optionally include more advanced features such as a display allocated to each channel to indicate the filename (or other identifier such as a track title) of a digital audio track currently being played, or having been selected to be played, under the control of that particular channel. By pressing a selection button allocated to each display the user may cycle the contents of the display to show other useful information such as the total duration of the track or the elapsed time thereof. It will be appreciated that this information could all be accommodated simultaneously in a sufficiently large display, and that additional controls may also be included to enable the user to select the track to be played from the collection available on the computer.

Additional tangible controls may also be included for each channel on the mixing deck, to provide real time digital effects such as echo, reverb and distortion to the digital audio signals being controlled. The effects are processed by the PC using known digital sound processing algorithms and the resulting digital signals are sent to the appropriate sound card for conversion into an audible signal. (Alternatively, on instruction via the mixing deck, effects may be applied by the sound card if its own processor has digital sound processing capability.)

Each channel may also be provided with a visual level meter to indicate the audio level of a digital audio signal being played. This may comprise a needle that swings across a calibrated scale, or a series of LEDs, or some other graphical display such as a liquid crystal matrix.

FIG. 2 illustrates schematically principal features of the electronic architecture of a mixing deck 30 electrically connected via a cable 49 (e.g. USB) to a computer 40. Standard internal features of the PC 40 such as memory have been omitted in the interest of clarity. The cable 49 is electrically coupled between the mixing deck's interface bus 39 and the PC's interface bus 48, providing a means for digital data communication from 72 the mixing deck's processor 32 to the PC's processor 42, and vice versa 70.

The PC's processor 42 is configured to receive 58 digital audio data from a source 44 such as the computer's hard drive. It is also electrically coupled 60 to a sound card 46 which provides an audio output 62. As discussed previously (and as shown in FIG. 1), this audio output 62 would typically be used to drive external speakers.

The mixing deck's processor 32 is electrically coupled to the user-operable controls 34, such that it can receive 50 instructions from the user. As discussed above, the mixing deck may also be provided with means 36 (e.g. displays or level meters) with which to supply 52 information to the user. The processor 32 is typically also electrically coupled 54 to a sound card 38, providing an audio output 56 for driving headphones.

On receiving 50 instructions from the mixing deck controls 34, the processor 32 sends digital instructions 72 to the PC's processor 42. In accordance with these instructions, the processor 42 processes the digital audio data it receives 58 from the digital audio data source 44. Two or more simultaneous streams of digital audio data can be processed by the processor 42. If the controls 34 have been set so as to mix two audio streams then this is performed by the processor 42 and the resultant digital audio stream is supplied 60 to the PC's sound card 46 for conversion to analogue signals for transmission 62 over speakers. However, if the controls 34 have been set to specify that an audio signal is to be supplied over headphones and not speakers, then the requisite processed digital audio data stream is supplied instead along the cable 49 to the processor 32, which then directs it 54 to the mixing deck's sound card 38 for conversion to analogue signals for transmission 56 over headphones. Commonly one data stream will be transmitted via the speakers whilst another is played over headphones, although, on instruction by the user via the controls 34 (specifically by moving the headphone selector knob 16 in FIG. 1 to a position such that neither channel is selected) the processor 32 will instruct the processor 42 to mix both data streams and supply the mixed signal to the sound card 46 for output over the speakers.

The cable 49 may also be used to provide a power supply to the mixing deck from the computer. Alternatively the mixing deck may have its own power supply such as a mains transformer.

Whilst the mixing deck would commonly be used to play MP3 files (or digital audio files of other formats) stored on the PC's hard drive, it may also be used to control the playing of CDs or minidisks (or other digital audio carriers) in drives under the control of the computer. The mixing deck may control music playback from CDs and minidisks using two possible methods, both of which require suitable software to be provided on the PC.

In the first method, the computer processor is configured to receive instructions from the user via the mixing deck, to take digital audio data directly from the CD or minidisk in response to those instructions, to process the digital data in accordance with other instructions supplied by the mixing deck (e.g. applying audio effects or altering the volume, as described previously), and then to play the audio through a sound card as specified by the user using the mixing deck.

The second method of using the mixing deck to control playback from the CD or minidisk drives comprises the user supplying commands to the mixing deck which are then interpreted by the PC to cause the CD or minidisk drives to play music directly through their own audio outputs. This method does not involve the computer processor itself handling digital audio data, but instead uses the mixing deck to control the music playback devices attached to the computer.

1. A computer peripheral device, electrically couplable to a personal computer having a processor operable to process digital audio data, the peripheral device comprising a user interface manually operable by a user to supply instructions to the said processor to specify processing operations to be performed by the processor on the digital audio data and to select an audio processing device for converting digital audio data to an analogue audio signal, the computer peripheral device further comprising an audio processing device for converting digital audio data to an analogue audio signal, said audio processing device being selectable by the user interface.

2. A computer peripheral device as claimed in claim 1, wherein the audio processing device for converting digital audio data to an analogue audio signal comprises a device selected from a group comprising: a sound card, an audio chipset.

3. A computer peripheral device as claimed in claim 2, further comprising a port for electrically coupling a pair of headphones to an output from the audio processing device.

4. A computer peripheral device as claimed in claim 2, further comprising a port for electrically coupling one or more speakers to an audio output from the audio processing device.

5. A computer peripheral device as claimed in claim 1, further comprising a headphone selector control operable to select a digital audio signal to be played over headphones and not over speakers.

6. A computer peripheral device as claimed in claim 1 being connectable to the computer via a USB cable.

7. A computer peripheral device as claimed in claim 1, wherein the manually operable user interface comprises controls operable to start and stop playing a digital audio signal.

8. A computer peripheral device as claimed in claim 1, wherein the manually operable user interface comprises a fader for adjusting the volume at which a digital audio signal is played.

9. A computer peripheral device as claimed in claim 1, further comprising controls operable to adjust the bass and treble of a digital audio signal being played.

10. A computer peripheral device as claimed in claim 1, further comprising controls operable to apply audio effects to a digital audio signal being played.

11. A computer peripheral device as claimed in claim 1, wherein the functions performed by the manually operable user interface may be assigned or reconfigured by a user.

12. A computer peripheral device as claimed in claim 1, wherein the manually operable user interface comprises a jog dial for cueing a digital audio signal to be played and/or for applying a DJ's scratching effect to a digital audio signal being played.

13. A computer peripheral device as claimed in claim 1, further comprising controls operable to select a digital audio signal to be played.

14. A computer peripheral device as claimed in claim 1, further comprising a display operable to show the filename or other identifier of a digital audio signal being selected or played, and/or its duration or elapsed time.

15. A computer peripheral device as claimed in claim 1, further comprising a visual level meter to indicate the audio level of a digital audio signal being played.

16. A computer peripheral device as claimed in claim 1, wherein the digital audio signals are in MP3 format.

17. A computer peripheral device as claimed in claim 1, wherein the digital audio signals are obtained from a CD or a minidisk under the control of the computer.

18. A computer peripheral device, electrically couplable to a personal computer such as an IBM-compatible or an Apple Macintosh computer having a processor operable to process digital audio data, the peripheral device comprising a user interface manually operable to cause the said processor to process the said digital audio data and to select the nature of the processing, the user interface comprising controls selected from a group comprising: moveable faders, jog dials.

19. A computer peripheral device electrically coupled to a personal computer having a processor operable to process digital audio data, the processor running software to configure it to respond to instructions provided by a manually-operable user interface on the peripheral device, the said instructions specifying processing operations to be performed by the processor on the digital audio data and selecting an audio processing device for converting digital audio data to an analogue audio signal.
